(19) United States
(12) Patent Application Publication
(10) Pub. No.: US 2023/0004930 A1
(43) Pub. Date: Jan. 5, 2023

(54) Preparation Of Food Onboard A Vehicle For Delivery

(71) Applicant: Wonder Group, Inc., New York, NY (US)

(72) Inventors: Andrew Schaeffer, Ridgewood, NJ (US); Stephen Toebes, New York, NY (US); David Veisz, New York, NY (US); William Bartz, Kansas City, MO (US)

(21) Appl. No.: 17/855,369

(22) Filed: Jun. 30, 2022

Related U.S. Application Data
(60) Provisional application No. 63/217,132, filed on Jun. 30, 2021.

(51) Int. Cl. G06Q 10/08; G06Q 30/06; G06Q 50/12

(52) U.S. Cl. CPC G06Q 10/0832; G06Q 30/0635; G06Q 10/087; G06Q 50/12

(57) ABSTRACT

A system and method for coordinating the preparation of food items onboard a mobile kitchen vehicle. An onboard computing system can receive first and second orders from a remote computing system and determine a preparation schedule for the first and second orders. The preparation schedule can be based on preparation instructions, estimated arrival times, and estimated delivery times. The onboard computing system can display pre-route preparation instructions and post-route preparation instructions for preparing food items of the first and second order so that the food items are delivered in an optimized condition.

### RELATED APPLICATIONS

The present application claims priority to U.S. Patent Application No. 63/217,132 filed on Jun. 30, 2021. The entire contents of the foregoing application are hereby incorporated herein by reference.

### TECHNICAL FIELD

Embodiments of the technology relate generally to preparation and delivery of food items onboard a vehicle.

### BACKGROUND

The popularity of food take-out and food delivery services continues to grow. The ability to prepare food for a customer during the delivery process can ensure that the customer receives the food in an optimal condition. However, preparing food during the delivery process can be complex because different food items require different types of preparation, different types of cooking instruments, and different amounts of time to complete the preparation. Preparing multiple food items and for multiple customers in different locations further increases the complexity. Considering these variables, coordinating the preparation of multiple types of food to optimize speed and to ensure the food is delivered in an optimal condition can be challenging. Accordingly, an efficient system for coordinating the preparation of food items for delivery would be beneficial.

### SUMMARY

In one example embodiment, a computer-implemented system can comprise a computing system onboard a mobile kitchen vehicle. At least one processor of the computing system can be configured for: receiving a first order and a second order from a remote computing system; determining a preparation schedule for the first order and the second order; displaying at a first time a first pre-route build instruction of the preparation schedule; after the mobile kitchen vehicle arrives at a first destination associated with the first order, displaying at a second time a first post-route build instruction of the preparation schedule; and receiving a first delivery confirmation that the first order has been delivered to a first customer.

The foregoing computer-implemented system can further comprise one or more of the following features. The at least one processor of the computing system can be configured for: receiving a first pre-route confirmation that the first pre-route build instruction of the preparation schedule is completed; transmitting the first pre-route confirmation to the remote computing system; receiving a first post-route confirmation that the first post-route build instruction of the preparation schedule is completed; and transmitting the first post-route confirmation to the remote computing system.

In the foregoing computer-implemented system, determining the preparation schedule can comprise: applying an estimated time of delivery and an estimated time of arrival to first preparation instructions associated with the first order. Determining the preparation schedule can further comprise: applying a second estimated time of delivery and a second estimated time of arrival to second preparation instructions associated with the second order. The at least one processor of the computing system can be further configured for: transmitting a pre-route cooking setting to an identified cooking system, the identified cooking system selected from among an oven, a fryer, a water bath (or rethermalizer), or a steamer onboard the mobile kitchen vehicle. The at least one processor of the computing system can be further configured for: after displaying the first post-route build instruction of the preparation schedule, receiving an acknowledgement that cooking has begun for the first post-route build instruction; setting a timer for the first post-route build instruction; and after expiration of the timer, displaying an instruction to stop the cooking for the first post-route build instruction. The at least one processor of the computing system can be further configured for: after receiving the first delivery confirmation, receiving an inventory update comprising items used for the first order; and transmitting the inventory update to the remote computing system.

In the foregoing computer-implemented system, the at least one processor of the computing system can be further configured for: displaying at a third time a second pre-route build instruction of the preparation schedule; after the mobile kitchen vehicle arrives at a second destination associated with the second order, displaying at a fourth time a second post-route build instruction of the preparation schedule; and receiving a second delivery confirmation that the second order has been delivered to a second customer.

In the foregoing computer-implemented system, the first pre-route build instruction and the first post-route build instruction can comprise instructions for the first order and the second order.

In another example embodiment, a computer-implemented method can comprise: receiving, at an onboard computing system of a mobile kitchen vehicle, a first order and a second order from a remote computing system; determining, by the onboard computing system of a mobile kitchen vehicle, a preparation schedule for the first order and the second order; displaying, by the onboard computing system of a mobile kitchen vehicle, at a first time a first pre-route build instruction of the preparation schedule; after the mobile kitchen vehicle arrives at a first destination associated with the first order, displaying, by the onboard computing system, at a second time a first post-route build instruction of the preparation schedule; and receiving, at the onboard computing system, a first delivery confirmation that the first order has been delivered to a first customer.

The foregoing computer-implemented method can further comprise one or more of the following features. The computer-implemented method can comprise: receiving, at the onboard computing system, a first pre-route confirmation that the first pre-route build instruction of the preparation schedule is completed; transmitting the first pre-route confirmation to the remote computing system; receiving, at the onboard computing system, a first post-route confirmation that the first post-route build instruction of the preparation schedule is completed; and transmitting the first post-route confirmation to the remote computing system.

The foregoing computer-implemented method can further comprise: applying an estimated time of delivery and an estimated time of arrival to first preparation instructions associated with the first order. Determining the preparation schedule can further comprise: applying a second estimated time of delivery and a second estimated time of arrival to second preparation instructions associated with the second order. The foregoing computer-implemented method can further comprise: transmitting a pre-route cooking setting to an identified cooking system, the identified cooking system selected from among an oven, a fryer, and a water bath (or rethermalizer), or a steamer onboard the mobile kitchen vehicle. The foregoing computer-implemented method can further comprise: after displaying the first post-route build instruction of the preparation schedule, receiving an acknowledgement that cooking has begun for the first post-route build instruction; setting a timer for the first post-route build instruction; and after expiration of the timer, displaying an instruction to stop the cooking for the first post-route build instruction. The computer-implemented method can further comprise: after receiving the first delivery confirmation, receiving an inventory update comprising items used for the first order; and transmitting the inventory update to the remote computing system.

The foregoing computer-implemented method can further comprise: displaying, by the onboard computing system, at a third time a second pre-route build instruction of the preparation schedule; after the mobile kitchen vehicle arrives at a second destination associated with the second order, displaying, by the onboard computing system, at a fourth time a second post-route build instruction of the preparation schedule; and receiving, at the onboard computing system, a second delivery confirmation that the second order has been delivered to a second customer.

In the foregoing computer-implemented method, the first pre-route build instruction and the first post-route build instruction can comprise instructions for the first order and the second order.

In yet another example embodiment, a non-transitory computer-readable medium can comprise instructions stored thereon that, when executed by one or more computer processors, cause the one or more computer processors to perform operations comprising: receiving a first order and a second order from a remote computing system; determining a preparation schedule for the first order and the second order; displaying at a first time a first pre-route build instruction of the preparation schedule; after the mobile kitchen vehicle arrives at a first destination associated with the first order, displaying at a second time a first post-route build instruction of the preparation schedule; and receiving a first delivery confirmation that the first order has been delivered to a first customer. In the foregoing example embodiment, the first pre-route build instruction and the first post-route build instruction can comprise instructions for the first order and the second order.

### BRIEF DESCRIPTION OF THE DRAWINGS

The accompanying drawings illustrate only example embodiments of a system and method for coordinating the preparation and delivery of food items and therefore are not to be considered limiting of the scope of this disclosure. The principles illustrated in the example embodiments of the drawings can be applied to alternate methods and systems. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a block diagram illustrating a system used for coordinating the preparation and delivery of food items in accordance with the example embodiments of the disclosure.

FIG. 2 is another block diagram illustrating a vehicle that is part of the system of FIG. 1 in accordance with the example embodiments of the disclosure.

FIG. 3A is an illustration of a method for coordinating the preparation of food items in accordance with the example embodiments of the disclosure.

FIG. 3B is an illustration of preparation instructions associated with food items in accordance with the example embodiments of the disclosure.

FIG. 4 is an illustration of another method for coordinating the preparation of food items in accordance with the example embodiments of the disclosure.

FIG. 5 is a block diagram of a computing system in accordance with the example embodiments of the disclosure.

### DETAILED DESCRIPTION OF EXAMPLE EMBODIMENTS

The example embodiments discussed herein are directed to systems and methods for preparing and delivering food items to customers. The examples described herein are in the context of a food preparation and delivery system that uses mobile kitchen vehicles. The mobile kitchen vehicles can receive customer orders for food items and chefs can prepare the food items using inventory and cooking systems onboard the mobile kitchen vehicle. A chef software application operating on an onboard computing system assists the chef in the preparation of the food items.

The chef software application can analyze numerous variables and devise an optimal schedule and sequence of instructions for preparing food items so that food is delivered to customers more quickly and with higher quality. The chef software application can analyze preparation instructions associated with multiple food items in multiple customer orders in determining the optimal sequence and schedule for a chef to perform each task in preparing the food items. The chef software application's analysis can also consider the multiple cooking systems available onboard the mobile kitchen vehicle and allocate the use of those cooking systems when there are multiple food items requiring the same cooking system. Preparation steps requiring more time can be started earlier, such as before the mobile kitchen vehicle departs for the next customer location. Additionally, because the chef software application can analyze multiple food items and multiple customer orders, the chef software application can look ahead at future orders and begin work on tasks requiring more time. In determining preparation schedules, the chef software application also can consider routing and customer location information to estimate when the mobile kitchen vehicle will arrive at the next customer location as well as future customer locations. Optimizing the timing for preparing each food item facilitates delivering the food items to the customer promptly after they are prepared so that the customer receives food in a hot and/or fresh condition.

The chef software application supports the work of the chef onboard the mobile kitchen system by allowing the chef to focus on the current cooking tasks that are to be completed. In other words, the chef software application allows the chef to avoid being overwhelmed with instructions for multiple orders containing multiple food items while at the same time trying to evaluate numerous variables relating to available cooking systems, preparation times for different items, and estimated times for arriving at multiple customer locations. The chef software application can display the current preparation instructions on which the chef can focus and can avoid burdening the chef with all of the other data the chef software application evaluates in devising preparation schedules. Allowing the chef to focus on the food items currently being prepared allows the chef to produce a higher quality product for the customer.

In the following paragraphs, the foregoing and other advantages of the disclosed embodiments will become more apparent. Particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

### Control Computing System and Mobile Kitchen Management System

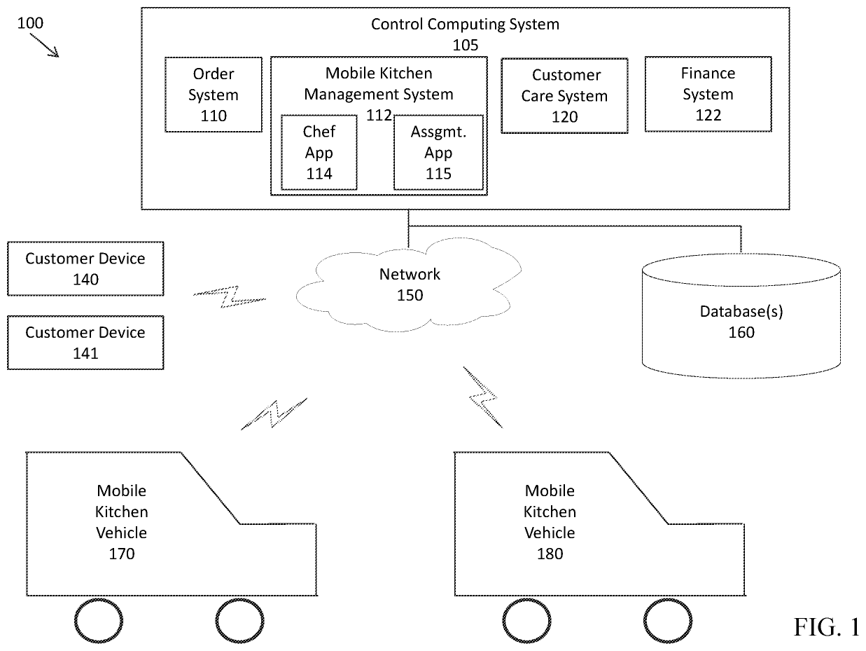

Referring now to FIG. 1, a block diagram is provided illustrating the architecture of an example food preparation and delivery system 100. The system 100 comprises a control computing system 105 (also referred to as a remote computing system) and mobile kitchen vehicles 170 and 180. While only two mobile kitchen vehicles 170 and 180 are illustrated in FIG. 1 for simplicity, it should be understood that the system is scalable and is designed to support many more mobile kitchen vehicles. The mobile kitchen vehicles communicate with the control computing system via a network 150 that can include one or more of a cellular mobile network, a wide area network, and the Internet. Additionally, customers can communicate orders for food items via network 150, or an alternate communications network, to the control computing system 105. The customers can communicate orders using a customer device 140 or 141, such as a mobile telephone, a smart phone, or a personal computer. While only two customer devices 140, 141 are illustrated in FIG. 1 for simplicity, it should be understood that the system is designed to support a large number of orders from a multitude of customer devices.

The example control computing system 105 comprises several subsystems illustrated in FIG. 1. The subsystems can be implemented as software, hardware, or a combination of software and hardware. Additionally, the subsystems can be implemented as software executing on the control computing system or they can be implemented as software or services implemented on separate or other remote computing systems in a distributed manner. While the subsystems illustrated in FIG. 1 are shown as discrete subsystems of the control computing system 105, it should also be understood that in some examples the subsystems can be combined with each other or with other subsystems not illustrated in the example of FIG. 1.

The subsystems of control computing system 105 include an order system 110 that receives orders for food items from customer devices. The order system 110 can include a user interface that receives information, queries, and food item selections from customer devices. The user interface of the order system 110 also can display on the customer devices available menu items based on the inventory onboard mobile kitchen vehicles near the customer's location as well as displaying an estimated time of delivery.

The order system 110 hands off customer orders to the mobile kitchen management system 112, which manages the assignment of orders to and communications with mobile kitchen vehicles 170, 180. As one example, the mobile kitchen management system 112 can include a chef application 114 and an assignment application 115. The assignment application 115 can retrieve data regarding the available mobile kitchen vehicles, their locations, their currently assigned customer orders, and their current inventory. The assignment application 115 can use the retrieved data to make assignments of new customer orders to mobile kitchen vehicles. For example, the assignment application 115 can identify mobile kitchen vehicles that are within a certain distance of a customer and that have the food items identified in the customer's order in onboard inventory. The assignment application 115 can select from among the identified mobile kitchen vehicles a mobile kitchen vehicle best suited to fulfill the customer order. Criteria for selecting a mobile kitchen vehicle can include proximity to the customer and the number of customer orders already assigned to the mobile kitchen vehicle. The assignment application 115 also can use the inventory data to determine when mobile kitchen vehicles need to be replenished with new food and supplies.

As will be described further below, the chef application 114 can analyze the customer orders assigned to a particular mobile kitchen vehicle, determine a preparation schedule for the food items in the customer orders, and present preparation instructions to a chef onboard the mobile kitchen vehicle. In addition to the assignment application 115 and the chef application 114, the mobile kitchen management system 112 can include other applications such as an image processing system that receives images from the mobile kitchen vehicles. For example, one or more cameras onboard the mobile kitchen vehicles can capture images associated with the food prepared onboard the mobile kitchen vehicle and those images can be transmitted via network 150 to the image processing system for use in supervising the preparation of the food items.

Additional example subsystems of control computing system 105 include a customer care system 120 and a finance system 122. The customer care system 120 can communicate with customer devices regarding reviews of food preparation and food delivery services and can address quality or service matters. The finance system 122 can manage the processing of payments from customer devices. Although not shown in the example of FIG. 1, control computing system 105 can include other subsystems such as business analytics subsystems that support or improve the food preparation and delivery system 100.

As illustrated in FIG. 1, the food preparation and delivery system 100 can also include one or more databases 160. The one or more databases 160 can store data used in connection with the foregoing subsystems such as the location, inventory, and assigned orders data associated with the various mobile kitchen vehicles. The databases 160 can also include data associated with customers such as order history or customer preferences that can be used to optimize the experience for the customers.

### Mobile Kitchen Vehicle and Chef Application

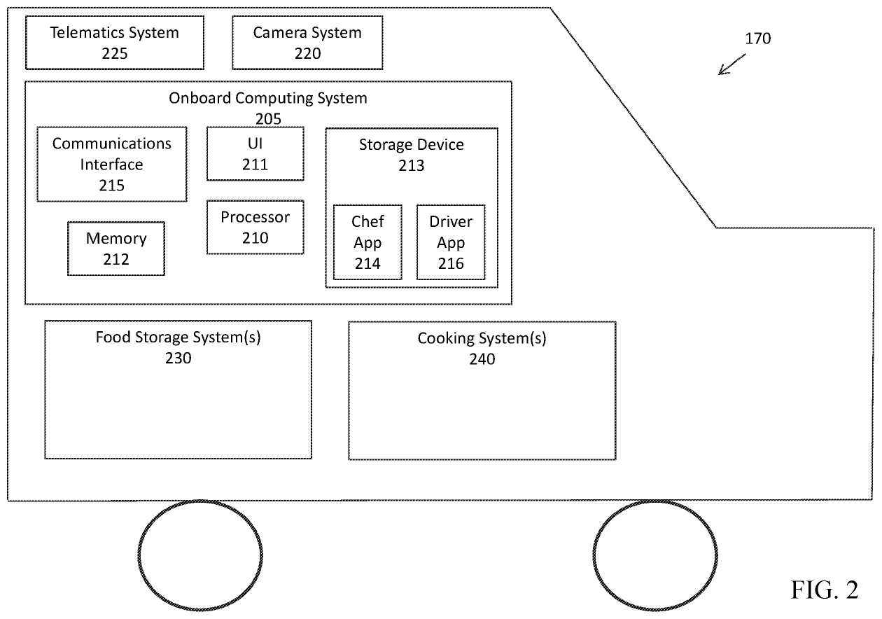

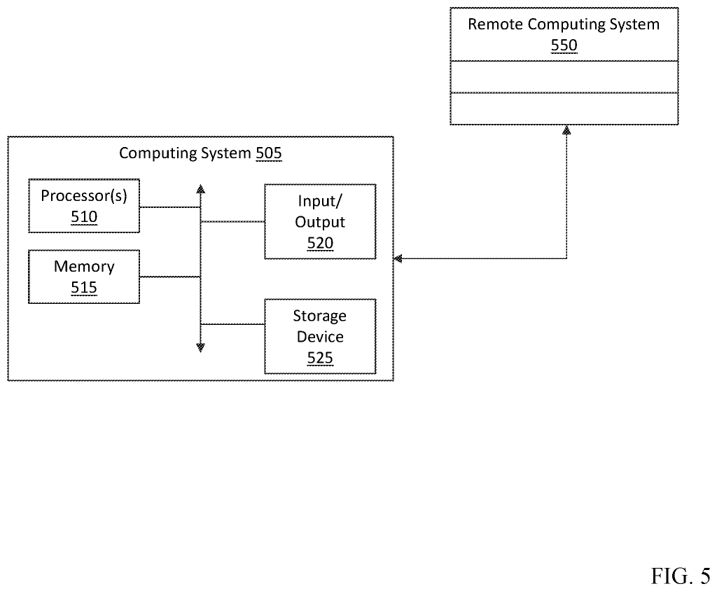

FIG. 2 illustrates a more detailed view of example mobile kitchen vehicle 170. The mobile kitchen vehicle 170 comprises a vehicle with subsystems including food storage systems 230, cooking systems 240, and an onboard computing system 205. The onboard computing system 205 can include a processor 210, memory 212, a communications interface 215, a user interface 211, and storage device 213. The components of the onboard computing system 205 are described in further detail below in connection with FIG. 5. The storage device 213 can store software that supports one or more persons, such as a chef or other personnel, working onboard the mobile kitchen vehicle 170. For example, the software can include a driver application 216 that assists a worker in navigating the mobile kitchen 170 to customer locations, commissaries, or supply replenishment centers.

The software also can include a chef application 214 that receives customer orders for food items, analyzes the customer orders, and provides a chef onboard the mobile kitchen 170 with instructions for preparing food items. The onboard computing system 205 can receive customer orders for food items from the mobile kitchen management system 112 via a communications network. In one example, the chef application is distributed in that it comprises a front end and a back end wherein the back end is chef application 114 of mobile kitchen management system 112 and the front end is chef application 214 stored on onboard computing system 205. The back end 114 and front end 214 of the chef application can communicate via network 150 allowing the chef to receive instructions for customer orders and to provide updates regarding the preparation of the customer orders. For instance, chef application 114 at the back end can receive customer orders from the assignment application 115 and can analyze the preparation instructions associated with food items in the customer orders to create a preparation schedule. The chef application 114 can transmit the preparation instructions and preparation schedule to chef application 214 at the front end for displaying to the chef via user interface 211.

In alternate embodiments, the chef application can have other configurations. For example, the analysis of the food preparation instructions and generation of a preparation schedule can be performed at the chef application 214 at the front end. Such an approach may be preferred where the connectivity via network 150 is limited. In yet another configuration, the chef application can be stored entirely at one location, either at the control computing system 105 or the onboard computing system 205.

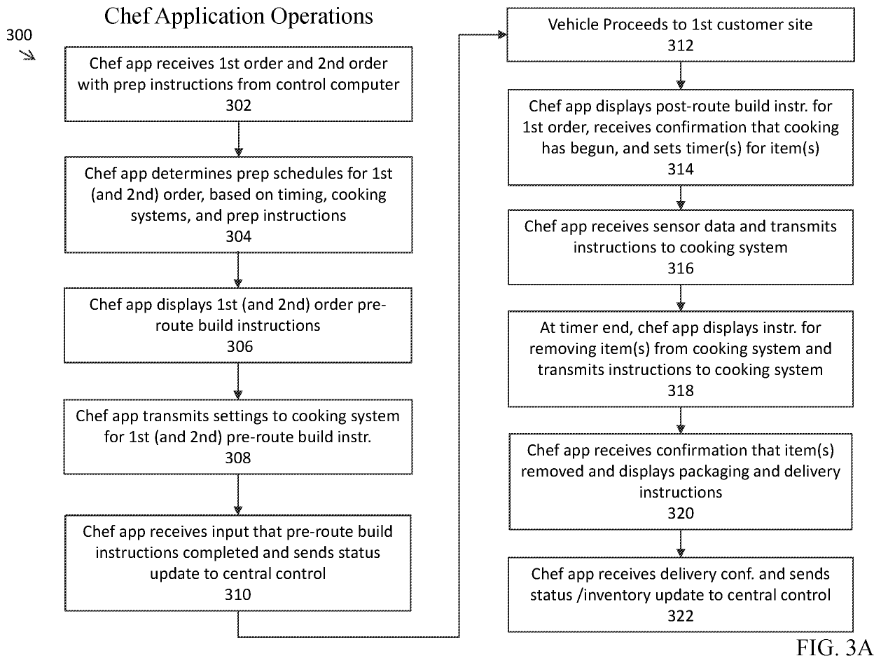

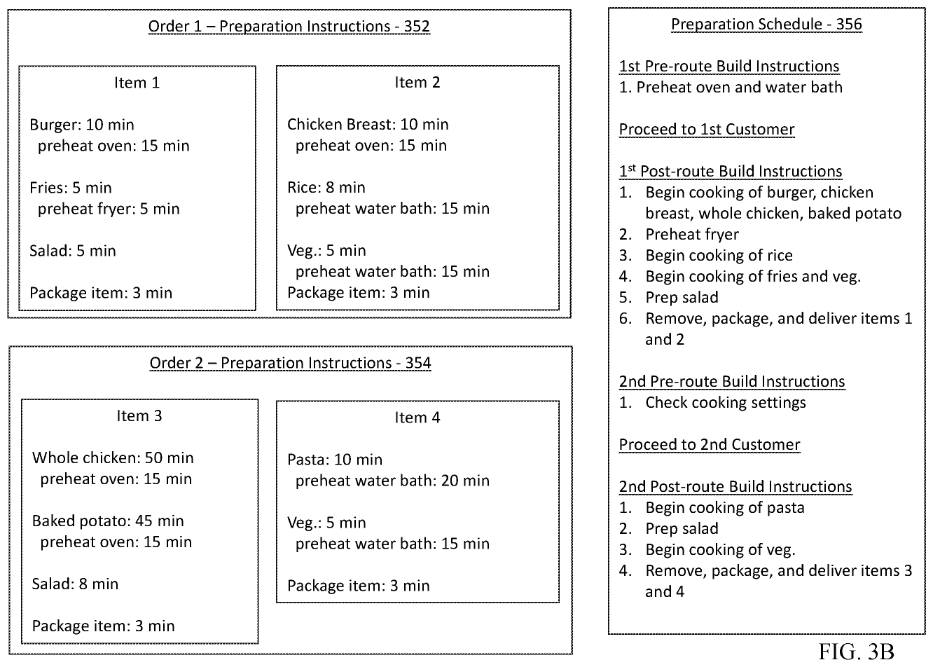

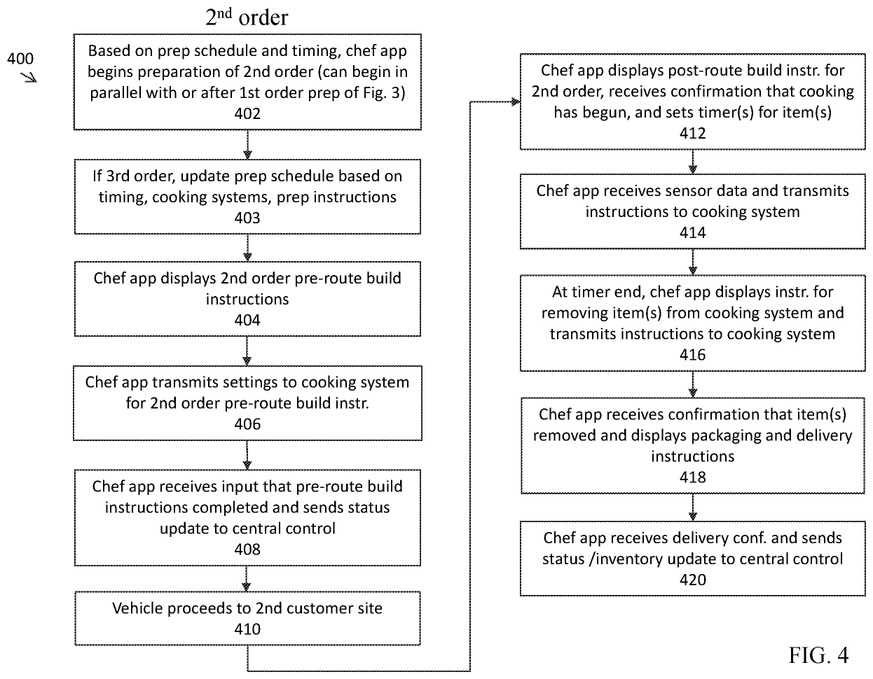

The customer orders for food items can be for one or more customers and each food item can have associated instructions for preparing the food items using the cooking systems 240, such as an oven, a fryer, a water bath (or rethermalizer), a steamer, or a warming cabinet, onboard the mobile kitchen vehicle. The food storage systems 230 can contain the ingredients, previously prepared food items, and partially prepared food items that are used in completing the customer orders. As described further below in connection with FIGS. 3A-4, the chef application 114, 214 analyzes preparation instructions associated with food items in the customer orders and determines an optimal sequence and schedule for preparing those food items. By optimizing the sequence and schedule of the preparation, food can be prepared and delivered to the customer more quickly and efficiently. For instance, preparation steps requiring more time can be started before the mobile kitchen vehicle departs for the next customer location. Additionally, because the chef application can analyze multiple food items and multiple customer orders, the chef application can look ahead at future orders, identify tasks requiring more time, and can consider routing and customer location information in determining the optimal times to begin certain of the preparation steps. Optimizing the timing for preparing each food item also facilitates delivering the food items to the customer promptly after they are prepared so that the customer receives food in a hot and/or fresh condition.

The chef application further assists the chef by performing the analysis of these various factors that affect the preparation schedule in the background, but only presenting the chef with limited tasks that are to be performed at the present time. This approach avoids overwhelming the chef with too much information and allows the chef to focus on the immediate tasks while the chef application plans ahead for the future preparation steps of the current customer order and future customer orders. The chef application can use the user interface 211 of onboard computing system 205 to control the amount of information displayed to the chef.

The user interface 211 of the onboard computing system 205 also can include one or more input devices that the chef can use to provide input to the onboard computing system 205. It can be advantageous if the input device does not require manual contact from the chef in order to keep the chef's hands free for food preparation. As one example, the input device can be a foot pedal that receives inputs from the chef as the chef progresses through a set of preparation instructions. As another example, the input device also can be a microphone that receives audible inputs from the chef. In yet other examples where manual contact by the chef is less of a concern, the display 430 can be a touch screen display that receives inputs from the chef.

Other systems onboard the mobile kitchen vehicle 170 can include a telematics system 225 and a camera system 220. The telematics system 225 can be used for communications between the onboard computing system 205 and the control computing system 105. The communications can include customer orders, status information regarding the preparation of customer orders onboard the mobile kitchen system, and data associated with the various systems onboard the mobile kitchen vehicle 170 including the cooking systems, the food storage systems, the camera systems, and the engine control system of the mobile kitchen vehicle 170. The camera system 220 can comprise one or more cameras located within the vehicle that can be used to track the progress and the quality of the food preparation. The cameras can supply images of a food item to the onboard computing system 205 and the images can be associated with the food item that is currently being prepared. When the preparation of a food item is completed, the chef can provide an input to the onboard computing system 205 indicating that the food item is completed. The camera system 220 can capture one or more images of the completed food item in its packaging.

The packaging can include a code, such as a bar code or a quick response code, that is visible on the packaging and that is captured in the images taken by the camera system 220. Once the camera system 220 captures an image of the completed food item with the code, the onboard computing system 205 can transmit a completion notification with an associated image to the mobile kitchen management system 112 of the control computing system 105. As described previously in connection with FIG. 1, an image processing system can analyze images received from the mobile kitchen vehicle. As one example, the image processing system can identify the code in the image and read a tracking identifier embedded in the code. Alternatively, the image processing system can use the code to obtain a tracking identifier in a look-up table. Once the tracking identifier is isolated, the mobile kitchen management system 112 can link the tracking identifier to a menu item identifier for the food item that was completed. The image of the completed food item and the tracking identifier can be stored in database 160 for future use in confirming the food item was completed, for quality control, or for other purposes.

### Chef Application Operations

Referring now to FIGS. 3A, 3B, and 4 example methods are illustrated for coordinating the preparation and delivery of food items using the example systems previously described in connection with FIGS. 1 and 2. The example methods illustrated in FIGS. 3A and 4 can include algorithms stored as computer-readable instructions in memory for execution by the various systems of the control computing system 105 and the onboard computing system 205.

Referring to FIG. 3A, a method is illustrated in accordance with the example embodiments of the present disclosure. Example method 300 can begin with operation 302 wherein the chef application receives a first order and a second order from the control computing system 105. As explained previously, the chef application can receive orders from the assignment application 115. The first order can be associated with a first customer at a first location and the second order can be associated with a second customer at a second location, wherein the second location is different from the first location. The first order and the second order can each comprise one or more food items and preparation instructions can be associated with each food item. The preparation instructions can take various forms. As one example, the preparation instructions can include a time for preheating cooking equipment and a time for cooking the food item. The preparation instructions can also include particular ingredients to be added to the food item, methods and timing for combining ingredients, condiments to be added to the food item after cooking, and presentation or packaging instructions for the food item.

For illustrative purposes, FIG. 3B provides an example of preparation instructions 352 associated with item 1 and item 2 of the first order as well as preparation instructions 354 associated with item 3 and item 4 of the second order. For clarity, the example preparation instructions illustrated in FIG. 3B are relatively simple in that they only include preheating time and cooking time for each of the food items to be cooked. However, in other examples, the other types of preparation information could be associated with each food item such as a time for combining ingredients as well as a method of combining the ingredients. The preparation instructions 352 and 354 can be considered potential preparation instructions that generally apply to each item. When a particular customer's order is considered, the customer may have customizations that modify or simplify the potential preparation instructions 352 and 354. Referencing item 3 as one example, the cooking of a whole chicken may have several potential preparation instructions relating to pre-cooking and post-cooking seasoning as well as sauces that can accompany the whole chicken. However, when a customer places a specific order for the whole chicken, the customer will make certain customization selections that may streamline or simplify the preparation instructions. Accordingly, the preparation instructions for a specific instance of a customer order can be referred to as a line build or build instructions. As will be described further with operation 304, FIG. 3B also illustrates a preparation schedule with build instructions associated with specific instances of food items as ordered by a customers.

Referring again to method 300 of FIG. 3A, in operation 304 the chef application determines preparation schedules for the first order and, optionally, the second order, based on the preparation instructions 352 and 354 of FIG. 3B, the cooking systems available on the mobile kitchen vehicle, and timing information. The cooking systems available on the mobile kitchen vehicle may vary in that in some cases there could be multiple cooking systems, such as multiple water baths or multiple oven bays, that allow for parallel preparation of multiple items. When preparing the preparation schedule, the chef application can analyze existing preparation schedules that may already be in the process of being completed for prior orders to assess when onboard cooking systems will be available. Additionally, the chef application can communicate with the cooking systems available on the particular mobile kitchen vehicle to determine the status and availability of cooking system resources. As an example, if two food items require cooking in an oven, but only one oven is available onboard the mobile kitchen vehicle, the chef application can set the preparation schedule so that one item is cooked first and then placed in an onboard warming cabinet while the second item is placed in the oven. Accordingly, the chef application can analyze multiple orders and formulate a preparation schedule that accounts for the multiple orders for multiple customer destinations that will be prepared using overlapping preparation schedules. Alternatively, in another example that is a simpler approach, the chef application may only analyze and formulate a preparation schedule for one order at a time.

The timing information considered in operation 304 can include one or both of the estimated time of delivery as well as the estimated time of arrival at the customer's location. The estimated time of arrival is the estimated time for arrival of the mobile kitchen vehicle at the customer's location and is significant because certain preparation instructions, referred to as post-route build instructions below, cannot be executed until the mobile kitchen vehicle arrives at the customer location. The estimated time of arrival at the customer's location will occur before the estimated time of delivery in that the estimated time of delivery is the time at which the completed food items have been packaged and delivered to the customer's door or other customer location. When the customer order was processed and assigned to the mobile kitchen vehicle by the assignment application 115, the assignment application 115 calculated an estimated time of arrival and an estimated time of delivery based on, the ordered items, the location of the customer, and other orders currently assigned to the mobile kitchen vehicle. As new information becomes available such as the completion of other existing orders or traffic patterns for the mobile kitchen vehicle's routes, the assignment application 115 can provide the chef application with updates to the estimated time of delivery.

In determining the preparation schedule in operation 304, the chef application can apply the estimated time of arrival to the preparation instructions 352 and 354, to identify preparation instructions that can be performed while the mobile kitchen vehicle is driving to the customer's location. In other words, these are pre-route preparation instructions because they can be commenced before the mobile kitchen vehicle begins driving the route to the first customer's location. In the example data illustrated in FIG. 3B, the estimated driving time to the customer's location for order 1 is 10 minutes and the chef application identifies the pre-heating of the oven and water bath, both requiring 15 minutes, as instructions that can be commenced before the mobile kitchen vehicle begins the 10 minute drive to the first customer's location. Therefore, using the estimated time of arrival, the chef application can categorize preparation instructions as either pre-route preparation instructions or post-route preparation instructions.

As illustrated in FIG. 3B, the chef application can use the preparation instructions 352 and 354 as well as the estimated time of arrival, i.e. the estimated driving time, to create build instructions for the specific instances of the food items the customer ordered. The preparation instructions categorized as pre-route become the pre-route build instructions and the preparation instructions categorized as post-route become the post-route build instructions. The chef application assembles the collection of build instructions into a preparation schedule 356. The preparation schedule 356 includes pre-route build instructions, driving instructions, and post-route build instructions, each of which can be displayed to the chef using the onboard computing system 205. Because the pre-heating of the oven and the water bath require more time than the driving time, these steps can be assigned to pre-route build instructions so they can be commenced before the mobile kitchen vehicle begins driving the route to the first customer and they can continue during the drive so that the oven and water bath will be ready for cooking when the mobile kitchen vehicle arrives at the first customer location. In contrast, in the example preparation schedule 356, the cooking of the items are placed in the post-route build instructions that are performed after the mobile kitchen vehicle arrives at the customer's location so that the items are fresh and hot when ready for delivery to the customer. As also illustrated in preparation schedule 356, the chef application can look ahead and schedule the second customer's orders. By scheduling the second customer's orders, the chef application is able to commence the early cooking of items that require more time, such as a whole chicken and a baked potato. Looking ahead to begin cooking items that require more time allows the system to use the driving time between customers more efficiently and to complete customer orders more promptly. Accordingly, the chef application can create a preparation schedule that interleaves build instructions for multiple orders along with driving instructions.

Referring again to method 300 of FIG. 3A, once the chef application has determined the preparation schedule 356, in operation 306, the chef application displays first pre-route build instructions so that the chef can begin pre-heating the oven and water bath. The chef application can display either the entire preparation schedule or only a portion of the preparation schedule such that the displayed tasks can be customized as needed to assist the chef. Additionally, the displayed driving instructions can include directions to the customer's location as well as customer-specific information such instructions for delivering the food items to a front or back door. Because the chef application also looks ahead at the second customer's order for items 3 and 4, the chef application can ensure that a sufficient number of oven bays and water baths are pre-heated for the items of both the first customer order and the second customer order. In operation 308, in response to the build instructions, the chef application can communicate pre-heating commands to the controllers that control the oven and the water bath. Alternatively, the chef onboard the vehicle can manually set the pre-heating temperatures of the oven and the water bath. In addition to providing commands to the cooking system controllers, the chef application can receive periodic data from sensors in the cooking systems to ensure they are operating at the desired temperatures. The chef application can also monitor each of the build instructions in the preparation schedule to ensure each is completed and to ensure there is no deviation from the preparation schedule. Accordingly, in operation 310, the chef application can receive confirmation that the pre-route build instructions are completed, such as an indication that the oven and water bath are powered on and are pre-heating. The confirmation can be in the form of a sensor reading provided to the chef application from each of the cooking systems. Alternatively, the confirmation can be in the form of an input from the chef indicating the pre-route build instructions have been completed.

In accordance with the preparation schedule, in operation 312 the chef drives the mobile kitchen vehicle to the first customer location. The driver application can assist the chef with navigation to the customer location as well as any specific delivery instructions such as delivery to a back door or other customer-specific instruction. While the mobile kitchen vehicle is proceeding to the first customer location, the chef application can continue to receive sensor data from sensors within the onboard cooking systems and can send new commands to the onboard cooking systems. For instance, if an unexpected delay occurs while in route to the first customer location, the chef application can send a command to the cooking systems to adjust the pre-heating by reducing the temperature or temporarily turning off the cooking systems. When an unexpected delay or change in scheduling occurs, the chef application also can adjust the subsequent steps of the preparation schedule so that items are cooked for the amount of time indicated in the preparation instructions. Adjusting the preparation schedule also facilitates the goal of preparing the food so that it is completed as soon as possible, but not too early such that the food's quality degrades while it sits in the mobile kitchen vehicle waiting to be delivered to the customer. In other words, it is preferable to time the cooking of food items for a customer so that the food items are completed as close as possible to the same time and when the mobile kitchen vehicle is at the customer's location so that the food items can be delivered together to the customer promptly after the cooking is completed, thereby providing the customer with the food items when they are hot and fresh.

The chef application also can receive updated information from the control computing system and make adjustments to the preparation schedule accordingly. As one example, if a customer makes a change to an order via the order system, the control computing system can relay the change to the chef application and the preparation schedule can be adjusted to reflect the change. Changes to a customer order might include exchanging one side item for another side item or modifying a customization such as a particular sauce to be used with the food item. The chef application's capability to change the preparation schedule while the operations of method 300 are being performed improves efficiency in the preparation of the food items and reduces food waste.

In operation 314, the chef application displays the post-route build instructions. The post-route build instructions can be limited to cooking of items for the first customer. Alternatively, as illustrated in the preparation schedule 356, the post-route build instructions can include instructions for items in the first customer's order as well as instructions for items in the second customer's order. Starting on items in the second customer's order allows for more prompt completion of items requiring more cooking time such as whole chicken or baked potato. In response to the chef application receiving confirmation that the cooking of the items identified in the post-route build instructions has begun, the chef application can set timers for each of the items to assist the chef with managing the cooking of multiple items simultaneously. The confirmation the chef application receives can be an input from the chef or can be sensor data input from one or more sensors in the cooking systems that detect placement of the food in the cooking systems. While the items in the post-route build instructions are cooking, the chef application can receive updates to customer orders, updates from the chef, and periodic data from the sensors of the cooking systems in operation 316. Additionally, in response to these updates and sensor data, the chef application can adjust the temperatures or other settings of the cooking systems by providing commands to the controller of the cooking systems.

When the timers lapse, the chef application can display instructions to the chef for removing the items from the cooking systems in operation 318. Alternatively, the chef application can send a command to the cooking systems to turn down the temperature or turn off the cooking system when the timers lapse. In cases where the oven or the water bath are not going to be used again immediately, the chef application can also provide commands to turn off the cooking systems.

In operation 320, the chef application receives confirmation, such as via an input from the chef or from a sensor in the cooking system, that the items have been removed from the cooking systems. In response, the chef application can display packaging and delivery instructions for the first customer's items.

In operation 322, the chef application receives confirmation from the chef that the first customer's items have been delivered and transmits the delivery confirmation to the control computing system 105. Additionally, in response to the delivery, the chef application can perform an inventory check by confirming via inputs from the chef which items and the number of items that were used in connection with the first customer's order. As one example, if food items or other supplies were dropped during the preparation, it may be the case that multiples of certain items were exhausted in connection with the first customer's order. The updated inventory data collected in the inventory check can be transmitted to the mobile kitchen management system operating at the control computing system and can be used to monitor inventory levels onboard the mobile kitchen vehicle.

Referring now to FIG. 4, another example method 400 for coordinating the preparation and delivery of food items is illustrated. Example method 400 relates to the preparation and delivery of the second customer order that was referenced in connection with FIGS. 3A and 3B. Example method 400 can continue with the preparation schedule 356 that was created in connection with FIG. 3A. Beginning with operation 402, the chef application can continue with the remaining build instructions of the preparation schedule for the second customer order. In some cases, the build instructions for the second order can be performed in parallel with or can overlap in time with the build instructions for the first order. In operation 402, the chef application also can update the preparation schedule based on any new data available with respect to the estimated time of arrival at the second customer or changes to customer orders. For example, the actual time required to complete the first customer order or changes in traffic patterns may impact the estimated time of arrival at the second customer location. As another example, in the case where the chef previously began cooking longer term items such as a whole chicken or a baked potato, the time for completion of those items may need to be adjusted if the first customer's order required more time than expected.

In operation 403, the chef application can check for additional orders that have been assigned to the mobile kitchen vehicle. The chef application can update the preparation schedule from method 300 to incorporate build instructions for food items of a third order associated with a third customer. Similar to the description of operation 304 provided above, the chef application evaluates estimated arrival and delivery times for the third customer, available cooking systems onboard the mobile kitchen vehicle, and the preparation instructions associated with the food items of the third order. The chef application uses the foregoing information to create build instructions for the third order that can be added to the preparation schedule. Additionally, the build instructions for the third order can affect the build instructions for the second order, such as the existence of cooking efficiencies when considering items of the second order and third order. Accordingly, in updating the preparation schedule with the build instructions for the third order, the chef application also can make adjustments to the build instructions for the second order when appropriate.

Operations 404 through 420 of method 400 are generally similar to operations 306 through 322 of method 300, except that they apply to the preparation of items 3 and 4 for the second customer's order. Referring to operation 404, the chef application displays the pre-route build instructions for the second order. Referencing the example of FIG. 3B, because the chef application has already begun the cooking of the longer term items and because the water bath is already pre-heated from the first customer's order, there are no pre-route build instructions other than to check on the status of the whole chicken and baked potato that are already in the process of being cooked.

In operation 406, the chef application can check the temperature settings of the cooking systems. In operation 408, the chef application can receive confirmation that the pre-route build instructions are completed. The confirmation can be in the form of a sensor reading provided to the chef application from each of the cooking systems such as an indication that the pre-heating has commenced. Alternatively, the confirmation can be in the form of an input from the chef indicating the pre-route build instructions have been completed. The chef application can communicate the completion of the pre-route build instructions to the control computing system 105.

In accordance with the preparation schedule, in operation 410 the chef drives the mobile kitchen vehicle to the second customer location. In operation 412, the chef application displays the post-route build instructions. As illustrated in the preparation schedule 356, the post-route build instructions are the remaining cooking instructions for items 3 and 4 of the second customer's order. In response to the chef application receiving confirmation that the cooking of the items identified in the post-route build instructions has begun, the chef application can set timers for each of the items to assist the chef with managing the cooking of multiple items simultaneously. While the items in the post-route build instructions are cooking, the chef application can receive periodic data from the sensors of the cooking systems in operation 414. Additionally, when needed, the chef application can adjust the temperatures or other settings of the cooking systems by providing commands to the controller of the cooking systems.

When the timers lapse, the chef application can display instructions to the chef for removing the items from the cooking systems in operation 416. In cases where the oven or the water bath are not going to be used again immediately, the chef application can also provide commands to turn off the cooking systems.

In operation 418, the chef application receives confirmation, such as via an input from the chef or an input of sensor data, that that the items have been removed from the cooking systems. In response, the chef application can display packaging and delivery instructions for the second customer's items.

In operation 420, the chef application receives confirmation from the chef that the second customer's items have been delivered and transmits the delivery confirmation to the control computing system 105. Additionally, in response to the delivery, the chef application can perform an inventory check by confirming via inputs from the chef which items and the number of items that were used in connection with the second customer's order. The updated inventory data collected in the inventory check can be transmitted to the mobile kitchen management system operating at the control computing system and can be used to monitor inventory levels onboard the mobile kitchen vehicle.

It should be understood that the operations illustrated in FIGS. 3A and 4 are only a representative example. In other embodiments, certain operations of methods 300 and 400 can be combined, performed in a different sequence, performed in parallel, or removed from methods 300 and 400. Furthermore, in other embodiments additional operations can be added to methods 300 and 400.

### Computing Systems

In certain embodiments, some or all of the processing operations described in connection with the foregoing methods can be implemented as computer-executable software. Software also may be referred to as an application, a program, a module, or code. Some or all of the processing operations described in connection with the foregoing methods can be performed by computing systems such as a tablet computer, a personal computer, a desktop computer, a centralized computer, or cloud computing systems. As explained previously, certain operations of the foregoing methods can be performed by a combination of computing systems.

Referring to FIG. 5, an example of a computing system is illustrated. The computing system 505 can represent a component of or one of the computing systems previously described herein, including a control computing system or onboard vehicle computing system. Computing system 505 includes one or more processors 510, a memory 515, an input/output device 520, and a storage device 525. Each of the components of the computing system 505 can be interconnected, for example, by a system bus. The components of computing system 505 shown in FIG. 5 are not exhaustive, and in some embodiments, one or more of the components shown in FIG. 5 may not be included in an example system. Further, one or more components shown in FIG. 5 can be rearranged.

The processor 510 can be one or more hardware processors and can execute computer-readable instructions, such as instructions stored in memory 515. The processor 510 can be an integrated circuit, a central processing unit, a multi-core processing chip, an SoC, a multi-chip module including multiple multi-core processing chips, or other hardware processor in one or more example embodiments. The hardware processor is known by other names, including but not limited to a computer processor, a microprocessor, and a multi-core processor.

The memory 515 can store information including computer-readable instructions and data associated with the previously described methods. The memory 515 can be cache memory, a main memory, and/or any other suitable type of memory. The memory 515 is a non-transitory computer-readable medium. In some cases, the memory 515 can be a volatile memory device, while in other cases the memory can be a non-volatile memory device.

The storage device 525 can be a non-transitory computer-readable medium that provides large capacity storage for the computing system 505. The storage device 525 can be a disk drive, a flash drive, a solid state device, or some other type of storage device. In some cases, the storage device 525 can be a database that is remote from the computing system 505. The storage device can store operating system data, file data, database data, algorithms, and software modules, as examples. In the case of the mobile kitchen vehicle's onboard computing system 205, the storage device can store algorithms embodying the operations of the methods described herein. The storage device can also store data related to food item preparation instructions, preparation schedules, cooking systems, tasks, and communications with the control computing system or other mobile kitchen vehicles.

Lastly, the input/output device 520 provides an interface to other devices, such as a microphone, a foot pedal input device, a touch screen interface, onboard cooking systems, and other computing systems such as remote computing system 550 (which can be the previously described control computing system illustrated in FIG. 1). The input/output device 520 can provide signal transfer links for communications with other devices and computing systems. The signal transfer links can include wired and/or wireless signal transfer links that transmit and receive communications via known communication protocols. For instance, the signal transfer links can provide wireless links to the control computing system 105 or other mobile kitchen vehicles. In some instances, the input/output device 520 can include a wired or wireless network interface device.

With respect to the example methods described herein, it should be understood that in alternate embodiments, certain steps of the methods may be performed in a different order, may be performed in parallel, may be combined, or may be omitted. Moreover, in alternate embodiments additional steps may be added to the example methods described herein. Accordingly, the example methods provided herein should be viewed as illustrative and not limiting of the disclosure.

Similarly, for any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Terms such as “first”, “second”, “remote”, “distal”, “proximal”, and “within” are used merely to distinguish one element (or part of an element or state of an element) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the embodiments may be practiced without these specific details. In other instances, well-known features have not been described in detail to avoid unnecessarily complicating the description.

Although example embodiments are described herein, it should be appreciated by those skilled in the art having regard to the present application that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A computer-implemented system comprising:
a mobile kitchen vehicle;
a computing system onboard the mobile kitchen vehicle, the computing system comprising at least one processor, wherein the at least one processor is configured for:
receiving a first order and a second order from a remote computing system;
determining a preparation schedule for the first order and the second order;
displaying at a first time a first pre-route build instruction of the preparation schedule;
after the mobile kitchen vehicle arrives at a first destination associated with the first order, displaying at a second time a first post-route build instruction of the preparation schedule; and
receiving a first delivery confirmation that the first order has been delivered to a first customer.

2. The computer-implemented system of claim 1, wherein the at least one processor is further configured for:
receiving a first pre-route confirmation that the first pre-route build instruction of the preparation schedule is completed;
transmitting the first pre-route confirmation to the remote computing system;
receiving a first post-route confirmation that the first post-route build instruction of the preparation schedule is completed; and
transmitting the first post-route confirmation to the remote computing system.

3. The computer-implemented system of claim 1, wherein determining the preparation schedule comprises:
applying an estimated time of delivery and an estimated time of arrival to first preparation instructions associated with the first order.

4. The computer-implemented system of claim 3, wherein determining the preparation schedule further comprises:
applying a second estimated time of delivery and a second estimated time of arrival to second preparation instructions associated with the second order.

5. The computer-implemented system of claim 3, wherein the at least one processor is further configured for:
transmitting a pre-route cooking setting to an identified cooking system, the identified cooking system selected from among an oven, a fryer, a water bath, and a steamer onboard the mobile kitchen vehicle.

6. The computer-implemented system of claim 5, wherein the at least one processor is further configured for:
after displaying the first post-route build instruction of the preparation schedule, receiving an acknowledgement that cooking has begun for the first post-route build instruction;
setting a timer for the first post-route build instruction; and
after expiration of the timer, displaying an instruction to stop the cooking for the first post-route build instruction.

7. The computer-implemented system of claim 6, wherein the at least one processor is further configured for:
after receiving the first delivery confirmation, receiving an inventory update comprising items used for the first order; and
transmitting the inventory update to the remote computing system.

8. The computer-implemented system of claim 1, wherein the at least one processor is further configured for:
displaying at a third time a second pre-route build instruction of the preparation schedule;
after the mobile kitchen vehicle arrives at a second destination associated with the second order, displaying at a fourth time a second post-route build instruction of the preparation schedule; and
receiving a second delivery confirmation that the second order has been delivered to a second customer.

9. The computer-implemented system of claim 1, wherein the first pre-route build instruction and the first post-route build instruction comprise instructions for the first order and the second order.

10. A computer-implemented method comprising:
receiving, at an onboard computing system of a mobile kitchen vehicle, a first order and a second order from a remote computing system;
determining, by the onboard computing system, a preparation schedule for the first order and the second order;
displaying, by the onboard computing system, at a first time a first pre-route build instruction of the preparation schedule;
after the mobile kitchen vehicle arrives at a first destination associated with the first order, displaying, by the onboard computing system, at a second time a first post-route build instruction of the preparation schedule; and
receiving, at the onboard computing system, a first delivery confirmation that the first order has been delivered to a first customer.

11. The computer-implemented method of claim 10, further comprising:
receiving, at the onboard computing system, a first pre-route confirmation that the first pre-route build instruction of the preparation schedule is completed;
transmitting the first pre-route confirmation to the remote computing system;
receiving, at the onboard computing system, a first post-route confirmation that the first post-route build instruction of the preparation schedule is completed; and
transmitting the first post-route confirmation to the remote computing system.

12. The computer-implemented method of claim 10, further comprising:
applying an estimated time of delivery and an estimated time of arrival to first preparation instructions associated with the first order.

13. The computer-implemented method of claim 12, wherein determining the preparation schedule further comprises:
applying a second estimated time of delivery and a second estimated time of arrival to second preparation instructions associated with the second order.

14. The computer-implemented method of claim 12, further comprising:
transmitting a pre-route cooking setting to an identified cooking system, the identified cooking system selected from among an oven, a fryer, a water bath, and a steamer onboard the mobile kitchen vehicle.

15. The computer-implemented method of claim 14, further comprising:
after displaying the first post-route build instruction of the preparation schedule, receiving an acknowledgement that cooking has begun for the first post-route build instruction;
setting a timer for the first post-route build instruction; and
after expiration of the timer, displaying an instruction to stop the cooking for the first post-route build instruction.

16. The computer-implemented method of claim 15, further comprising:
after receiving the first delivery confirmation, receiving, at the onboard computing device, an inventory update comprising items used for the first order; and
transmitting the inventory update to the remote computing system.

17. The computer-implemented method of claim 10, further comprising:
displaying, by the onboard computing system, at a third time a second pre-route build instruction of the preparation schedule;
after the mobile kitchen vehicle arrives at a second destination associated with the second order, displaying, by the onboard computing system, at a fourth time a second post-route build instruction of the preparation schedule; and
receiving, at the onboard computing system, a second delivery confirmation that the second order has been delivered to a second customer.

18. The computer-implemented method of claim 10, wherein the first pre-route build instruction and the first post-route build instruction comprise instructions for the first order and the second order.

19. A non-transitory computer-readable medium comprising instructions stored thereon that, when executed by one or more computer processors, cause the one or more computer processors to perform operations comprising:
receiving a first order and a second order from a remote computing system;
determining a preparation schedule for the first order and the second order;
displaying at a first time a first pre-route build instruction of the preparation schedule;
after the mobile kitchen vehicle arrives at a first destination associated with the first order, displaying at a second time a first post-route build instruction of the preparation schedule; and
receiving a first delivery confirmation that the first order has been delivered to a first customer.

20. The computer-readable medium of claim 19, wherein the first pre-route build instruction and the first post-route build instruction comprise instructions for the first order and the second order.
